(19) United States
(12) Patent Application Publication
(10) Pub. No.: US 2006/0020788 A1
(43) Pub. Date: Jan. 26, 2006

(54) Self-service terminal

(75) Inventors: Richard A. Han, Angus (GB); Andrew Monaghan, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/159,083

(22) Filed: Jun. 22, 2005

(30) Foreign Application Priority Data
Jul. 2, 2004 (GB) 0414840.9

(51) Int. Cl. H04L 9/00

(52) U.S. Cl. 713/165

(57) ABSTRACT

A self-service terminal comprising a core unit (10) that includes a processor and one or more peripheral devices (14) operable to communicate with the core (10). Included in each of the core (10) and the peripheral devices (14) are means for encrypting messages (20, 22) using key based encryption, so that messages can be securely sent between them. The key based encryption uses a session key for encrypting messages and public/private key based encryption, such as RSA, for key management purposes. An initial session key is generated in the peripheral device in response to the detection of a pre-determined act or event. Once a suitable session key is created, it is encrypted using the public key of the public/private key pair and sent to the core (10), where it is decrypted using the private key to expose the session key. This session key is then used to encrypt/decrypt all messages sent between the core (10) and the peripheral device (14).

### BACKGROUND

The present invention relates to a self-service terminal, such as an automated teller machine (ATM).

Self-service terminals are increasingly making use of peripheral devices, for example dispensers, card readers, printers etc, that are connected by open, standardized communication links such as USB and RS232. The nature of such communication links is that they are insecure, opening the door to various attacks on system security such as passive attacks, e.g., eavesdropping to obtain private information, and active attacks, e.g., sending a command to a cash dispenser to dispense money without authorization. Historically, the industry has avoided this problem by using proprietary communication links or unpublished message formats. However, these increase cost and decrease interoperability.

### SUMMARY

According to one aspect of the present invention, there is provided a self-service terminal comprising a core; one or more peripheral devices operable to communicate with the core, and means for encrypting signals for sending between the core and the one or more peripheral devices. Preferably, the means for encrypting are operable to use key based encryption.

By encrypting messages for sending between the core and the peripheral devices, security can be improved. This makes the terminal less susceptible to fraud.

The key based encryption may be symmetric key encryption. This may be used for transmitting messages between the core and the peripheral device.

The key based encryption may be asymmetric key encryption. This may be used for key management purposes.

The peripheral device may be operable to generate a session key and use that key to encrypt messages for sending to the core. The peripheral device may be operable to generate the session key using a random or pseudo-random key generation process. Preferably, the peripheral device is operable to encrypt the session key and send the encrypted key to the core. The peripheral device may be operable to encrypt the session key using a public key of a public/private key pair. In this case, the core includes or has access to the private key of the public/private key pair and is operable to use the private key to decrypt the session key, and store that session key for decrypting subsequent messages from the peripheral device.

The peripheral device may be operable to generate an initial session key in response to detection or sensing of a predetermined act or event. The pre-determined act may be a pre-determined physical or mechanical act. Where the peripheral device is a cash dispenser, the pre-determined act may be opening of a safe door or activation/de-activation of a lock mechanism associated with the safe. In either case, a sensor may be provided for directly or indirectly sensing the pre-determined act.

The peripheral device may be operable to change the session key. The peripheral device may be operable to encrypt the new session key using the current session key and additionally a public key of a public/private key pair. The peripheral device may be operable to change the session key after expiry of a pre-determined time. The peripheral device may include a timer for determining when the pre-determined time has elapsed.

The peripheral device may be operable to include in each message a number that is incremented/decremented each time a new message is sent, and encrypt at least the part of the message that includes the number. In practice, this means that each new message should have a number that is uniquely associated with it. The core may be operable to monitor the numbers in each message received. The core may be operable to keep a record of the numbers already received, and compare the numbers of newly received messages with those stored numbers. In the event that the newly received number is the same as one of the previously received numbers, the core is adapted to recognize that this is either an error or an attempted fraud. Alternatively or additionally, the core may merely compare the number of the newly received message with an expected number. Again in the event that there is a discrepancy, this would be indicative of an error or fraud.

Preferably a plurality of peripheral devices is provided. Each peripheral device includes means for generating a session key, which key can be uniquely identified with it.

According to another aspect of the present invention, there is provided a method for initializing a secure communication process in a self-service terminal comprising a core, and one or more peripheral devices operable to send messages to the core, the method comprising sensing a pre-determined act or event at the peripheral device; in response to sensing of the pre-determined act or event, generating within the peripheral device a session key; encrypting that session key; sending the encrypted session key to the core, decrypting the session key and storing the session key in a secure area.

The session key may be encrypted using an asymmetric encryption process. The session key may be encrypted in the peripheral device using a public key of a public/private key pair. The session key may be decrypted in the core using the private key of the public/private key pair.

According to yet another aspect of the present invention, there is provided a peripheral device for use in a self-service terminal comprising a central control unit or core, the device comprising means for sensing a pre-determined act or event at the peripheral device; means for generating a session key in response to sensing of the pre-determined act or event; means for encrypting that session key, and means for sending the encrypted session key to the core.

### BRIEF DESCRIPTION OF THE DRAWINGS

Various aspects of the invention will now be described by way of example only and with reference to the accompanying drawings, of which:

FIG. 1 is a block diagram of an ATM that includes a central processor connected to a peripheral device, and an indication of a data flow for a terminal initialization process;

FIG. 2 is a block diagram that is similar to that of FIG. 1, except in this case the data flow shown is for an encrypted message transfer process, and

FIG. 3 is a block diagram that is similar to that of both FIGS. 1 and 2, except the data flow shown is for a process for changing a session key.

### DETAILED DESCRIPTION

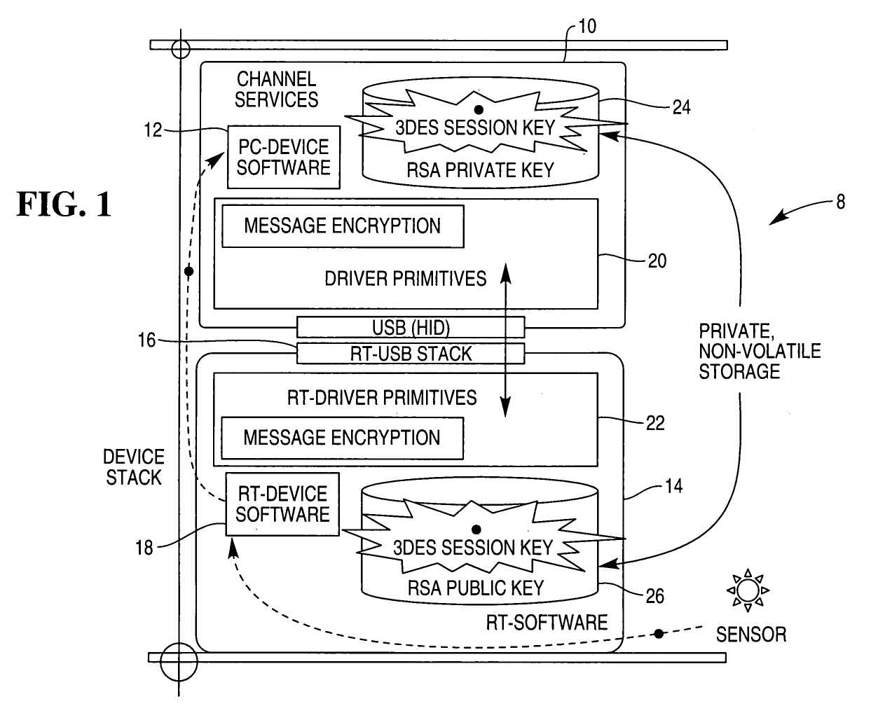

FIG. 1 shows an automated teller machine 8 that includes a central processor unit or core 10 having internal software 12, labeled PC-device software, and processing capabilities for controlling terminal functionality and sending messages to or receiving messages from one or more peripheral devices 14 (only one shown) and a remote host (not shown). The core 10 is connected to the peripheral device 14 using a standard communications link 16 such as a USB/Real Time USB stack. Included in the peripheral device 14 is real-time software 18 for sending messages to or receiving messages from the core 10. Each of the core 10 and the peripheral device 14 includes software for encrypting/decrypting messages 20 and 22 respectively and a secure area 24 and 26 respectively for storing encryption keys for use in the encryption/decryption processes. Typically the secure areas 24, 26 are areas of private, non-volatile memory.

Any suitable encryption technique can be used for encrypting messages for sending between the control unit 10 and the peripheral device 14 via the communication link 16. In the terminal of FIG. 1, symmetric key and public key encryption are both used, for example triple DES symmetric key encryption and RSA. Symmetric key encryption is used for encrypting messages and public key encryption is used for key management purposes, such as session key encryption and decryption. This will be described in more detail later. These techniques are well known and so will not be described herein.

In order to implement the encryption/decryption, encryption keys are stored in the secure areas 24, 26 of both the core 10 and the peripheral device 14. For asymmetric encryption, each has to share a common public/private key pair. For symmetric encryption, each has to have access to the same session key. To this end, the central unit 14 includes a private key, preferably a RSA private key, a public key, again preferably a RSA public key, and a triple-DES session key. The peripheral device includes a public key, again preferably a RSA public key, and a 3DES session key. The real-time software 20 and the control software in the core 10 have built in knowledge of the relevant public key encryption system.

Each of the public and private keys is generated externally of the terminal 8. The public key is stored in the persistent memory 24 of the core 10 and peripheral devices 14. The private key is stored in only the core 10. Storing the public and private keys is done when then terminal is being built and/or developed. As will be appreciated, if this key pair is updated, for example, if the initial pair is compromised, then both the PC device software 12 and the RT-device software 18 need to be redeployed at the same time. This may require a firmware update on the device. In contrast, the session key is generated by the peripheral device 14. After generation, the session key is stored in the internal memory of the device and then encrypted using the public key and sent to the core 10

For security reasons prior to installation neither the core 10 nor the peripheral device 14 includes a copy of the session key. Instead, this is generated in the peripheral device 14 as part of an initialization process. In order to initialize the peripheral device 14 of FIG. 1, that device 14 is configured to detect a pre-determined authorized act or event, typically using a sensor provided on the device. Where the peripheral device that is being connected is a cash dispenser, the pre-determined act could be opening of or accessing the interior of the safe. To this end, a sensor may be provided on or associated with the safe door for detecting when the safe is legitimately opened. Alternatively, the sensor may be connected to or associated with the safe lock mechanism. Detecting acts associated with the safe is a useful means for triggering generation of the initial session key, because only personnel with high-level security access can physically open the safe.

In the event that the dispenser 14 is opened, and the safe is accessed, this is recognized by the dispenser as authorization to generate an initial session key. The dispenser firmware then generates a random session key and stores it in the private, non-volatile location of memory 26. The session key is then encrypted with the firmware's public key and sent to the PC device software 12 via the USB driver 16. Once received, the software 12 is able to decrypt the message using the private key and so reveal the newly generated session key. The PC device software 12 must securely hide the private key to prevent the session key being decrypted by an attacker. The PC device software 12 then stores the session key in a private, non-volatile area, so that both the core 10 and the peripheral device 14 share the same, common session key.

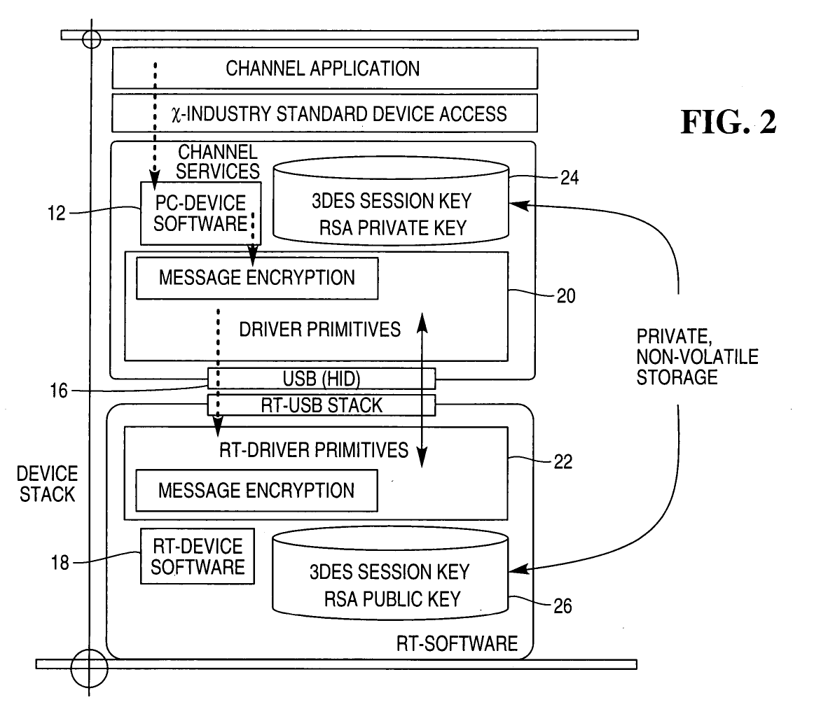

Once the session key is generated and the core 10 and peripheral device 14 initialized, messages sent between them can be encrypted using the session key. FIG. 2 shows the data flow when a message is to be sent from the core 10 to the peripheral device 14. The actual message structure and protocols can be of any suitable form. In the event that a message is to be sent from the core 10 to the peripheral device 14, the message is generated and/or identified as being for the peripheral device 14 and sent to the encryption-aware PC-device software 12. The PC-device software 12 directs the message to the encryption software 20, which uses the stored session key to encrypt the device message. The encrypted message is then sent to the RT-device software 18, which uses the encryption/decryption software 22 and its copy of the session key to decrypt the message.

This encryption facility provides confidentiality for messages being sent to and from the core 10 and the peripheral device 14. To improve security further and provide authentication, a simple incrementing command sequence number can be included inside the encrypted message. This is useful because while encryption provides some protection against all passive attacks and some active attacks, there is a particular active attack known as message replay that encryption alone cannot prevent. Message replay involves recording a message with a known effect on its way to or from a device, with the intention of later replaying the message to simulate a valid device communication. For example, if a command to dispense cash is recorded it might be replayed (sent to the dispenser) in an attempt to dispense more cash without authorization. This is not prevented by encryption since the attacker does not need to inspect or understand the contents of the data packet. By including an incrementing sequence number in the encrypted portion of messages, there is provided a mechanism for ensuring that a replayed message is not accepted as authentic. Because the incrementing sequence number is inside the encrypted portion of the message it cannot be altered or inspected, but can be verified by the receiving node to ensure that the message is not a repeat of an earlier message.

To deal with the inclusion of the simple incrementing command sequence, the core 10 is operable to monitor the numbers in each message received. This can be done in various different ways. For example, the core 10 may keep a record of the numbers already received, and compare the numbers of newly received messages with those stored numbers. In the event that the newly received number is the same as one of the previously received numbers, the core 10 is adapted to recognize that this is either an error or an attempted fraud. Alternatively or additionally, the core 10 may merely compare the number of the newly received message with an expected number. Again in the event that there is a discrepancy, this would be indicative of an error or fraud.

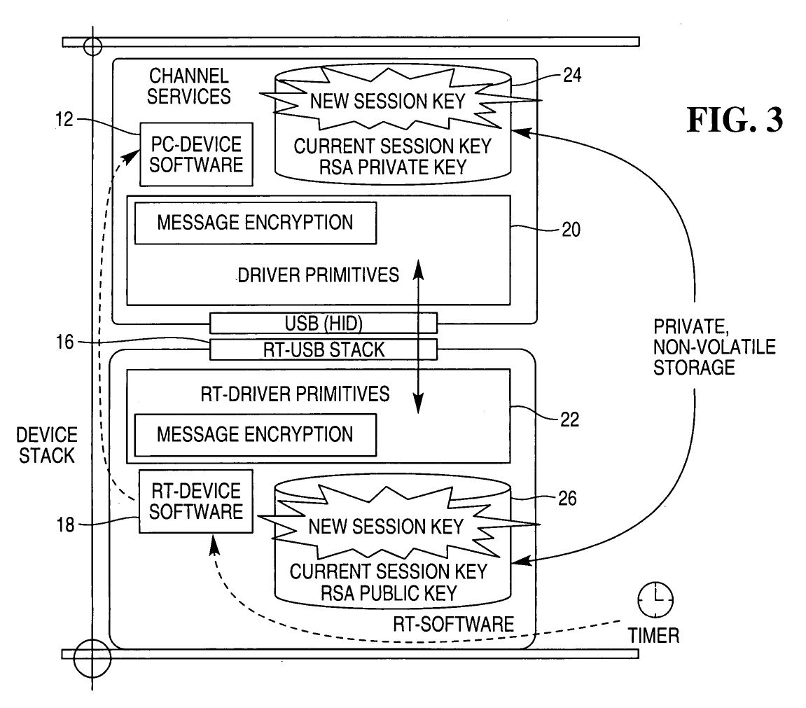

Further security may be provided by having periodic changes of session key. FIG. 3 shows the process steps for causing a session key up-date. In this case, the RT-device software 18 in the peripheral device 14 is operable to decide, based upon a timer, when a session key should no longer be used. In the event that a decision is taken that a session key should not be used, the RT-software 18 is operable to generate a random new session key and store it in its secure memory. The new session key is then encrypted using the public key and additionally the current session key and sent across the link 16 to the PC-device software 12. The PC-device software 12 is operable to decrypt this message using its private key and the current session key. The PC-device software 12 is operable to recognize that the decrypted new session key is to replace the current key, and so stores it securely for future communication with the device. At the same time, the old session key is deleted.

Using a session key as part of the encryption process provides protection against what is sometimes referred to as a “rogue host” attack. In this type of attack, a peripheral device, such as the cash dispenser, is unplugged from the core USB 16 and plugged into a notebook PC instead. The notebook PC can have the appropriate device driver software available such that when the device is connected, an application-programming interface is installed by the plug-and-play driver installation. However, this rogue host cannot be allowed to drive the device without authorization. In particular, the rogue PC cannot control the device without the session key. Furthermore, the host PC cannot initiate the generation of a new session key for device communications. This can only be done by the peripheral device 14 itself, and only when a trusted party has verified that the device is correctly connected to the control unit in the terminal. The trusted party must also prove that they are authorized to generate a new session key by accessing a secure trigger mechanism, for example, proving access to the safe. Any periodic expiration of a session key must be negotiated for using the new session key encrypted with the old session key. This means that a rogue host cannot wait for key expiration to establish communications with a device.

The terminal in which the invention is embodied prevents unauthorized access to security-critical system devices, in an open standard interface to drive the device (e.g., CEN XFS). Hence, a proprietary API is not needed. The terminal can also be used in an open, extendible PC host system, with no restrictions on level of change that can be applied to the PC system software. For example, new applications can be added by authorized means without preventing device access. The invention also allows the use of industry standard, strong encryption methods to prevent an attacker infiltrating the system. In practice, this means that a casual attack will not succeed. In addition, since the terminal in which the invention is embodied is independent of any particular PC peripheral device interconnection technology, it is well suited to standard connection methods such as RS232 or USB.

A skilled person will appreciate that variations of the disclosed arrangements are possible without departing from the invention. For example, not all messages passed between a peripheral device and its associated control unit need be encrypted. The choice of which messages to encrypt is the decision of the device software-knowledge that is shared by both the RT-software and the device personality. Generally, a device would not necessarily need to encrypt messages that do not present a security risk, for example retrieving an operational status value from the device. Accordingly the above description of the specific embodiment is made by way of example only and not for the purposes of limitation. It will be clear to the skilled person that minor modifications may be made without significant changes to the operation described.

What is claimed is:

1. A self-service terminal comprising:
a core unit including a processor;
one or more peripheral devices operable to communicate with the core; and
means for encrypting signals for sending between the core and the one or more peripheral devices.

2. A self-service terminal as claimed in claim 1, wherein the peripheral device is operable to generate a session key, and use the session key to encrypt messages for sending to the core.

3. A self-service terminal as claimed in claim 2, wherein the peripheral device is operable to generate the session key using a random or pseudo-random key generation process.

4. A self-service terminal as claimed in claim 3, wherein the peripheral device is operable to encrypt the session key and send the encrypted key to the core.

5. A self-service terminal as claimed in claim 4, wherein the peripheral device is operable to encrypt the session key using a public key of a public/private key pair, and the core is operable to decrypt the session key using the private key of the public/private key pair.

6. A self-service terminal as claimed in claim 2, wherein the peripheral device is operable to generate an initial session key in response to detection or sensing of a pre-determined act or event.

7. A self-service terminal as claimed in claim 6, wherein a sensor is provided in the peripheral device for directly or indirectly sensing the pre-determined act or event.

8. A self-service terminal as claimed in claim 7, wherein the pre-determined act is a pre-determined physical or mechanical act.

9. A self-service terminal as claimed in claim 8, wherein the peripheral device is a cash dispenser, and the pre-determined act is opening of a safe door or activation/de-activation of a lock mechanism associated with the safe.

10. A self-service terminal as claimed in claim 2, wherein the peripheral device is operable to change the current session key with a new session key.

11. A self-service terminal as claimed in claim 10, wherein the peripheral device is operable to encrypt the new session key using the current session key and additionally a public key of a public/private key pair and send the encrypted session key to the core.

12. A self-service terminal as claimed in claim 11, wherein the peripheral device is operable to change the session key after expiry of a pre-determined time.

13. A self-service terminal as claimed in claim 11, wherein the peripheral device is operable to include in each message a unique number or other identifier, and encrypt at least the part of the message that includes the number.

14. A self-service terminal as claimed in claim 13, wherein the core is operable to monitor the number or identifier in each message received and use this to identify replay messages.

15. A self service terminal as claimed in claim 14, further comprising a plurality of peripheral devices, each operable to generate its own unique session key.

16. A method of initializing a secure communication process in a self-service terminal comprising a core, and one or more peripheral devices operable to send messages to the core, the method comprising:
sensing a pre-determined act or event at the peripheral device;
in response to sensing of the pre-determined act, generating within the peripheral device a session key;
encrypting the session key;
sending the encrypted session key to the core;
decrypting the session key; and
storing the session key in a secure area.

17. A method as claimed in claim 16, wherein encrypting the session key involves using an asymmetric encryption process.

18. A peripheral device for use in a self-service terminal, the peripheral device comprising:
a core;
means for sensing a pre-determined act or event at the peripheral device;
in response to sensing of the pre-determined act, means for generating within the peripheral device a session key;
means for encrypting the session key; and
means for sending the encrypted session key to the core.

19. A device as claimed in claim 18, wherein the pre-determined act or event is a pre-determined mechanical or physical act or event.

20. A device as claimed in claim 19, further comprising a sensor for sensing the pre-determined act or event.
